(19) United States
(12) Patent Application Publication
(10) Pub. No.: US 2007/0203973 A1
(43) Pub. Date: Aug. 30, 2007

(54) Fuzzing Requests And Responses Using A Proxy

(75) Inventors: Lawrence G. Landauer, Woodinville, WA (US); Alan J. Myrvold, Redmond, WA (US); Thomas P. Gallagher, Redmond, WA (US); Daniel Ricker, Redmond, WA (US); Hassan Sultan, Seattle, WA (US); Ivan Medvedev, Bellevue, WA (US); Adel Abouchaev, Redmond, WA (US); Peter Oehlert, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/276,454

(22) Filed: Feb. 28, 2006

(51) Int. Cl. G06F 15/16

(52) U.S. Cl. 709/203; 709/227

(57) ABSTRACT

A system for fuzzing requests and responses using a proxy includes a client that may include a client application, a server that may include a server application, and a proxy coupled between the client and the server. The proxy communicates message traffic between the client and the server related to testing the client application or the server application. The proxy is adapted to store a template resulting from the message traffic into a data store to facilitate later fuzzing of requests or responses contained in the message traffic. A user interface for presenting events resulting from the fuzzing is also described.

### BACKGROUND

Fuzzing refers to a process of altering the data of test cases so as to generate new test cases. Test data may be fuzzed to test a variety of different types of software. Typically, the fuzzing process is automated, guided by alterations programmed by a human tester.

Existing fuzzing techniques may not collect the data that results from the fuzzing operations in one location. Thus, it may be difficult to correlate the results from a variety of different test runs, and determine which set of test conditions caused a particular error to occur. In the context of testing an application in a client-server environment, a server application may be tested by submitting a large number of test requests to it. If one of these numerous requests crashes the server or causes the server to fail, it may be difficult to isolate which particular request, sequence of requests, or other circumstances led to the failure.

Typical fuzzing techniques involve testing, for example, a server application by creating an “artificial” client application that sends fuzzed requests to the server application under test. Therefore, the testers typically would possess detailed knowledge regarding the format and content of the services offered by the server under test, and would implement the artificial client application accordingly. However, this detailed knowledge may be expensive to acquire, and may further limit how widely a given fuzzing test application may be deployed. If another server application is to be tested, the artificial client application may need to be recreated, at least in part.

### SUMMARY

Systems, methods, and/or techniques (“tools”) for fuzzing requests and responses using a proxy are described herein. A system for fuzzing requests and responses using a proxy interface includes a client that, in turn, includes a client application. The system can also include a server that includes a server application. The system also includes a proxy coupled between the client and the server. The proxy communicates message traffic between the client and the server, and the message traffic may be related to testing the client application or the server application. The proxy stores a template resulting from the message traffic into a data store to facilitate later fuzzing of requests or responses that are contained in the message traffic. A user interface for presenting events resulting from the fuzzing is also described.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTIONS OF THE DRAWINGS

Tools for fuzzing requests and responses using a proxy are described in connection with the following drawing figures. The same numbers are used throughout the disclosure and figures to reference like components and features. The first digit in a reference number indicates the drawing figure in which that reference number is introduced.

FIG. 1 is a block diagram of an operating environment suitable for fuzzing requests and responses using a proxy.

FIG. 2 is a block diagram of an operating environment as configured to test a server and/or a server application using the proxy.

FIG. 3 is a block diagram of an operating environment as configured to test a client and/or a client application using the proxy.

FIG. 4 is a flow diagram of a process for creating and storing templates, such as the templates shown in FIGS. 1-3.

FIG. 5 is a flow diagram of a process for configuring the client, the proxy, and/or the server for testing the client application or the server application.

FIG. 6 is a flow diagram of a process for performing fuzzing after the proxy has been configured and started.

FIG. 7 is a flow diagram of a process for handling a fuzzed request or response at a server or client under test.

FIG. 8 is a diagram of a user interface that may be presented to the tester to view results of the testing involving fuzzing requests and responses using a proxy.

### DETAILED DESCRIPTION

Overview

The following document describes tools capable of performing and/or supporting many techniques and processes. The following discussion describes exemplary ways in which the tools provide for fuzzing requests and responses using a proxy. This discussion also describes other techniques and/or processes that may be performed by the tools.

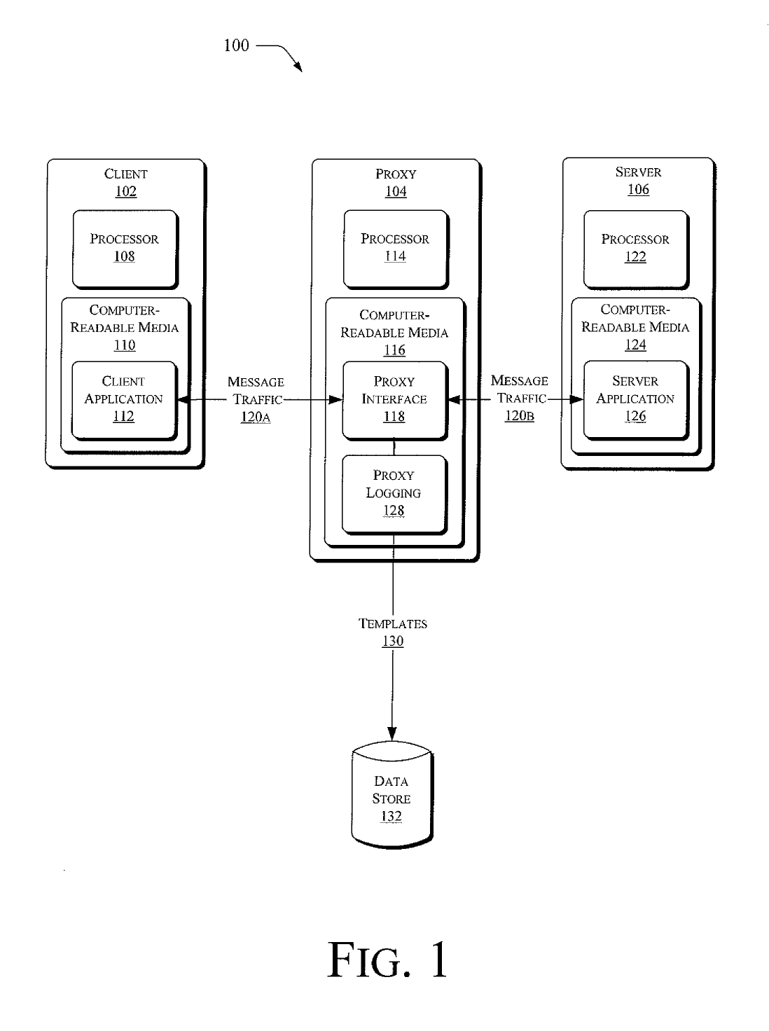

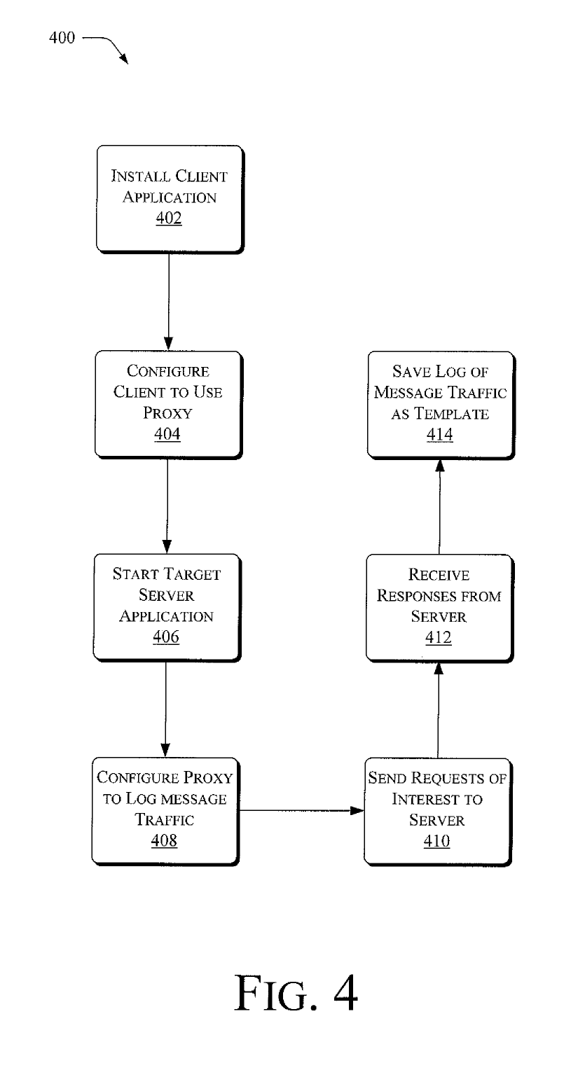

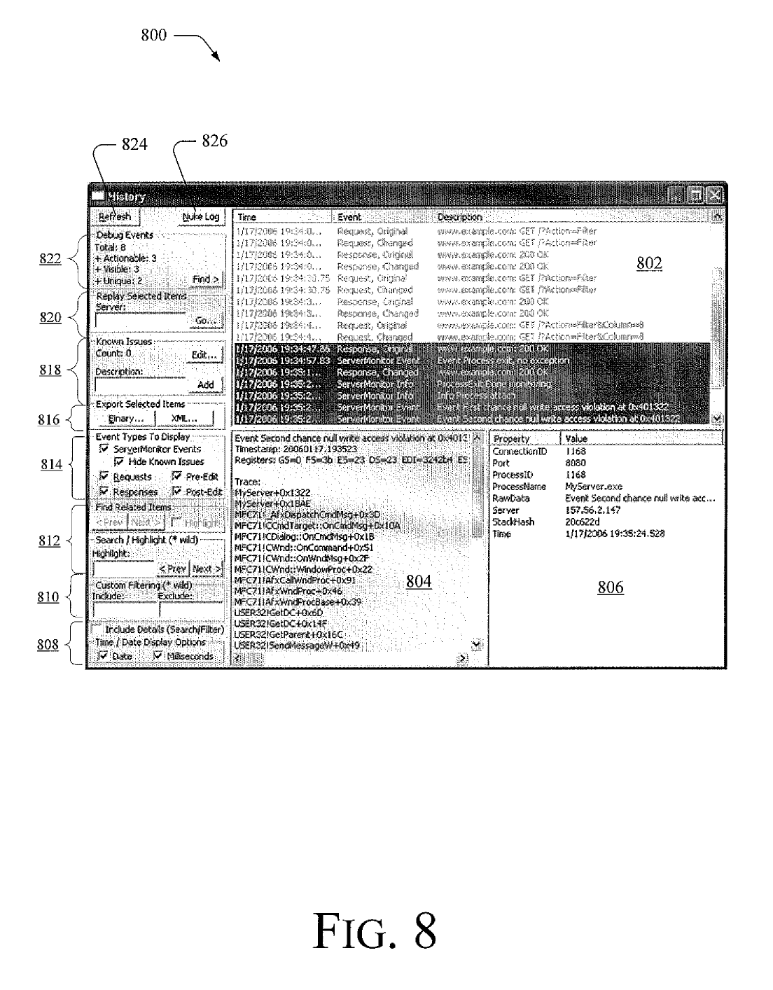

For convenience only, but not limitation, this document is organized into sections, with the sections introduced by corresponding headings. First, Operating Environments are described in connection with FIGS. 1-3. Next, Process Flows are described in connection with FIGS. 4-7. Finally, an example User Interface is described in connection with FIG. 8.

Operating Environments

FIG. 1 illustrates an operating environment 100 suitable for fuzzing requests and responses using a proxy. The operating environment 100 may include one or more clients 102, proxies 104, and servers 106. FIG. 1 shows one representative client 102, proxy 104, and server 106 only for convenience of illustration, but not to limit possible implementations of the operating environment 100. In general, the client 102 may be adapted to present one or more requests to the server 106, and the server 106 may be adapted to provide responses to those requests. The proxy 104 may be coupled between the client 102 and the server 106, such that the requests and responses pass through the proxy 104.

In general, the operating environment 100 may include one or more clients 102. The client 102 may include one or more processor(s) 108 and computer-readable media 110. The computer-readable media 110 may contain instructions that, when executed by the processor 108, perform any of the tools described herein. The processor 108 may be configured to access and/or execute the instructions embedded or encoded onto the computer-readable media 110. The processor 108 may also be categorized or characterized as having a given architecture. The client 102 may comprise a computing device, such as a network or other server, a desktop computer, a laptop or notebook computer, or any other computing device configured to perform the functions described herein in connection with the client 102.

The computer-readable media 110 may include one or more client applications 112; FIG. 1 shows one client application 112 for convenience only. In general, the client application 112 generates requests to the server 106, and receives responses thereto. For example, the client application 112 may be a web browser. The client application 112 may be implemented as a module, program, or other entity capable of interacting directly or indirectly with one or more entities external to the client 102.

The proxy 104 may also include a processor and computer-readable media, referenced at 114 and 116, respectively. The computer-readable media 116 may include a proxy interface 118 that is adapted to receive requests from the client 102, and to pass responses to the client 102. For convenience only, the requests and responses passing between the client 102 and the proxy 104 are represented generally as message traffic 120a.

The proxy interface 118 may also be adapted to pass requests to the server 106, and to receive responses from the server 106. For convenience only, the requests and responses passing between the proxy 104 and the server 106 are represented generally as message traffic 120b.

The server 106 may include a processor and computer-readable media, referenced at 122 and 124, respectively. The computer-readable media 124 may include one or more server applications 126; FIG. 1 shows one server application 126 for convenience only. In general, the server application 126 receives requests from the proxy 104, and provides responses thereto. For example, the server application 126 may be a web server. The server application 126 may be implemented as a module, program, or other entity capable of interacting directly or indirectly with one or more entities external to the server 106.

It is noted that the client 102, the proxy 104, and the server 106 are shown as separate entities in FIG. 1 only to facilitate discussion of functions performed by each. However, the operating environment 100 shown in FIG. 1 is illustrative, rather than limiting. More particularly, it is noted that one or more of the client 102, the proxy 104, and the server 106 may be implemented on the same physical machine. For example, in a testing environment, the client 102, the proxy 104, and the server 106 may be implemented one physical machine. In such implementations, the client 102, the proxy 104, and/or the server 106 may share one or more processors and/or computer-readable media.

Additionally, implementations of the operating environment 100, as well as other operating environments described herein, may include more than one proxy 104. For example, the various functions described herein as being performed by the proxy 104 may be distributed across more than one proxy 104 without departing from the scope and spirit of the description herein.

The proxy 104 may include a proxy logging component 128 that is operative to receive respective sets of requests and corresponding responses that pass between the client 102 and the server 106, through the proxy interface 118. Recall that FIG. 1 represents these requests and responses generally as message traffic 120a and 120b (collectively, message traffic 120). The proxy logging component 128 may organize and track these requests and corresponding responses, and store them as templates 130 in a data store 132. It is understood that FIG. 1 shows one data store 132 for convenience only. The templates 130, or other data described herein, could also be distributed across multiple data stores 132 as well in implementations of the description herein.

As discussed in further detail below, the data store 132 may store the results of submitting one or more requests to the server 106, and receiving responses thereto. The data store 132 may also store the results of fuzzing one or more requests submitted to the server 106, or of fuzzing one or more responses provided to the client 102. Without loss of generality, term “fuzzing” refers to altering or transforming at least part of the data used to test a computer program, so as to generate a new test case.

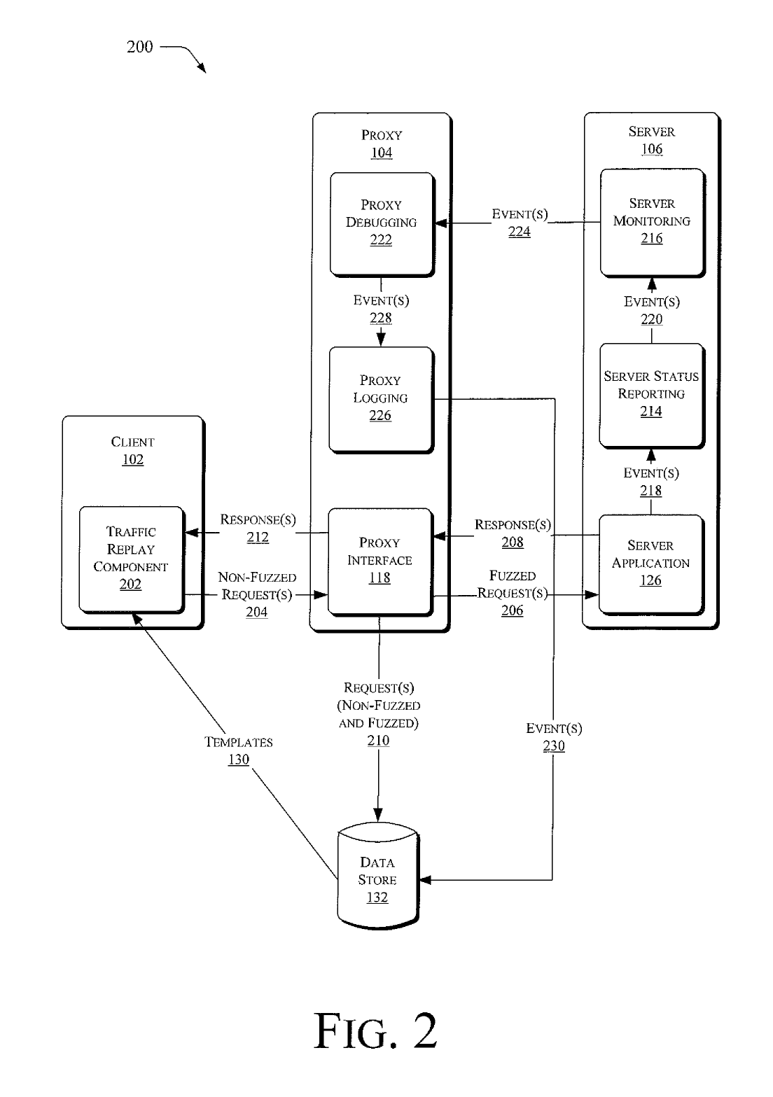

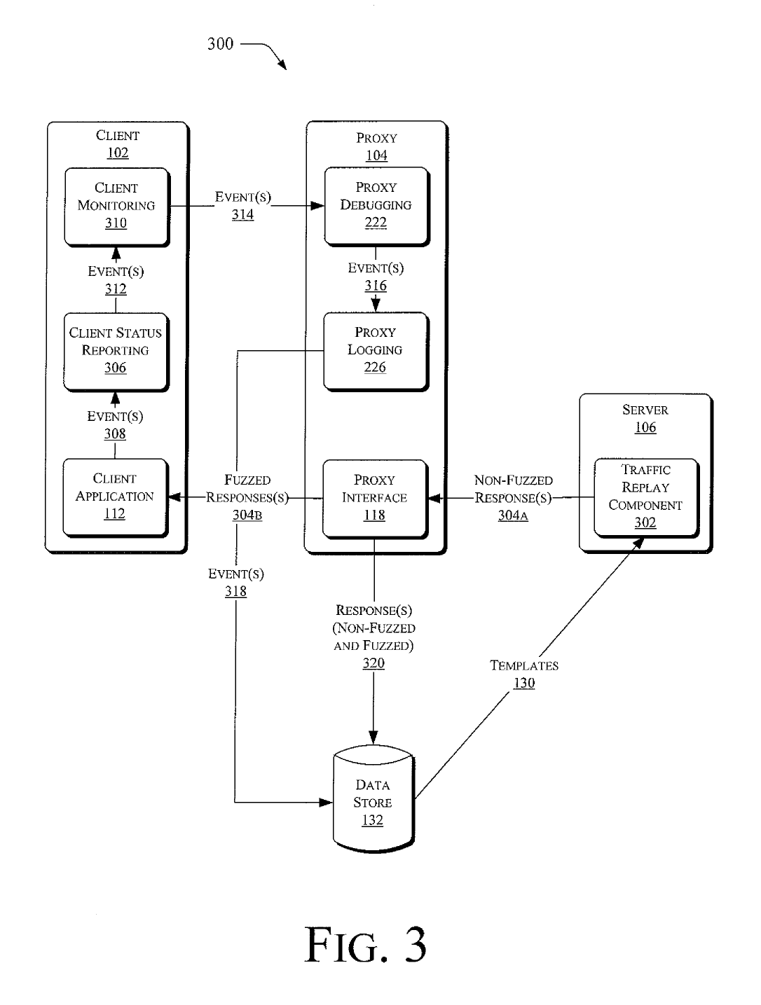

The templates 130 that result from the message traffic 120 may be input to the proxy 104 as potential test cases for testing the components of the client 102 and/or the server 106. More particularly, the client application 112 and/or the server application 126 may be tested, as described further below in connection with FIGS. 2 and 3. FIG. 2 illustrates testing the server 106 and/or the server application 126 by fuzzing requests to the server 106. FIG. 3 illustrates testing the client 102 and/or the client application 112 by fuzzing responses to the client 102.

FIG. 2 illustrates features of an operating environment 200 as configured to test the server 106 and/or the server application 126. Some elements that were described in FIG. 1 are carried forward into FIG. 2, and are denoted by the same reference numerals. Generally, the operating environment 200 may be operative to test the server 106 and/or the server application 126 by submitting fuzzed requests to it, and evaluating how the server 106 and/or the server application 126 responds to the fuzzed requests. For convenience in continuing the description, any reference to the server 106 may be considered to be a reference to the server application 126 also.

The client 102 may obtain one or more templates 130 from the data store 132. The templates 130 represent ordinary, expected message traffic 120 that would pass between the client 102 and the server 106. The message traffic 120 may take the form of messages exchanged under, for example, the HTTP, SOAP, or other protocols. The client 102 may include a traffic replay component 202 that is adapted to receive the templates 130 from the data store 132. The traffic replay component 202 may submit one or more requests 204 to the proxy 104, for example, the proxy interface 118.

If fuzzing is enabled, the proxy 104 evaluates the request 204 to determine whether it meets any criteria applicable to fuzzing requests. If the request 204 meets the criteria, the proxy 104 fuzzes the request 204 and passes it to the server 106. The request 204 as fuzzed and passed to the server 106 is denoted as fuzzed request 206. The proxy interface 118 may log the non-fuzzed request 204 and the fuzzed request 206 in the data store 132.

The server 106 receives the fuzzed request 206. At the server 106, the fuzzed request 206 is processed by, for example, the server application 126. If the server application 126 processes the fuzzed request 206 successfully, the server 106 may return a response 208 to the proxy 104. In some instances, the proxy interface 118 may log the response 208 in the data store 132, to be associated with the non-fuzzed request 204 and the fuzzed request 206 stored previously. For convenience of illustration only, the non-fuzzed request 204, the fuzzed request 206, and/or the response 208 as stored in the data store 132 are represented in FIG. 2 by the reference 210. The proxy 104 may forward the response 208 to the client 102, as denoted at reference 212.

Returning to the server 106, the server 106 may include a server status reporting component 214 and a server monitoring component 216. At least these components 214 and 216 may be implemented in the computer-readable media 124. However, FIG. 2 omits the computer-readable media 124 for clarity.

The server status component 214 may take the form of, for example, an application debugger, a memory profiling tool, or the like. Respective instances of the server status component 214 may be associated with corresponding instances of the server application 126. For example, if the server application 126 spawns several different executing threads or processes, instances of the server status component 214 may be associated with these different threads or processes.

The server status component 214 may be configured to detect occurrences of pre-defined events 218, such as memory faults, access violations, buffer overflows, allocations or deallocations of memory, or the like. The events 218 may be reported in connection with details relating to the events 218, such as call stacks, contents of debug registers, exception types, or the like.

If the server 106 and/or the server application 126 generates an event 218, the server status component 214 captures these events 218, and reports them to the server monitoring component 216. Within a given server 106, the server monitoring component 216 may receive reports of events 218 from one or more server status components 214. For convenience, the events 218 as reported to the server monitoring component 216 are denoted at reference 220. The events 220 may be considered to represent all events of interest that occur in any process executing on the server 106.

The server monitoring component 216 may notify the proxy 104 of any events 220 reported by the server status component 214. The proxy 104 may include a proxy debugging component 222 that is adapted to receive notifications of the events 220 as they occur on the server 106. For convenience, the events 220 as reported to the proxy 104 are denoted at reference 224. The events 224 may be considered to represent all events of interest that occur in any process executing on the server 106, as reported to the proxy 104. These events 224 may also include cases where processes running on the server 106 stop executing without warning. Additionally, the server monitor 216 may report events that are not specific to a particular process, such as overall CPU usage, non-paged memory usage, free disk space, or the like. For example, such events may be reported when predefined thresholds have been met or exceeded.

The proxy 104 may also include a proxy logging component 226 that is operative to receive notifications of events 224 and related details, which are denoted generally in FIG. 2 at reference 228. The proxy logging component 226 may log the events 228 into the data store 132, so as to associate the events 228 with the requests 204 and/or fuzzed requests 206 that triggered the events 228. The details related to each event 228 (e.g., call stacks, contents of debug registers, exception types, or the like) may also be stored with the corresponding event 228. The stored event 228 and related details as stored in the data store 132 are denoted in FIG. 2 at reference 230. Specifically, the data store 132 may be formatted so as to support iteratively replaying the request-response traffic and to correlate failures (as reported in the events 230) with the specific responses and/or requests that led to the failures.

In the foregoing manner, the traffic replay component 202 emulates the client application 112, and enables testing of the server application 126. In some instances, the server application 126 may be tested without the client application 112 running on the client 102.

The foregoing discussion of FIG. 2 described aspects of the example operating environment 200 suitable for testing the server 106 and/or the server application 126 by fuzzing the requests 206 submitted thereto. The discussion turns to a description of an example operating environment as adapted to test the client 102 and/or the client application 112 by fuzzing responses provided thereto, now presented with FIG. 3.

FIG. 3 illustrates features of an operating environment 300 as configured to test the client 102 and/or the client application 112. Some elements that were described in FIGS. 1 and 2 are carried forward into FIG. 3, and are denoted by the same reference numerals. Generally, the operating environment 300 may be operative to test the client 102 and/or the client application 112 by submitting fuzzed responses to it, and evaluating how the client 102 responds to the fuzzed responses.

To facilitate testing the client 102 and/or the client application 112, the server 106 may include a traffic replay component 302, which may be implemented in the computer-readable media 124 shown in FIG. 1. The computer-readable media 124 is omitted from FIG. 3 for clarity.

The traffic replay component 302 may be implemented similarly to the traffic replay component 202 shown in FIG. 2, and may function similarly. To initiate testing the client 102 and/or the client application 112, the traffic replay component 302 may obtain one or more templates 130 from the data store 132. Recall that the templates 130 represent previously-executed requests and corresponding responses that were compiled and stored by, for example, the operating environment 100 shown in FIG. 1.

The traffic replay component 302 may analyze the templates 130 to extract the responses received to certain requests. For convenience, the responses as passed from the server 106 to the proxy 104 are denoted as responses 304a. The responses 304a are provided to the proxy interface 118. One or more criteria may specify which responses 304a are eligible for fuzzing and presentation to the client 102 as test cases. The proxy interface 118 evaluates whether the responses 304a meet these eligibility criteria. If so, the proxy interface 118 fuzzes the responses 304a and presents them to the client 102. For convenience, the fuzzed responses are denoted in FIG. 3 at reference 304b.

The client 102 may receive and process the fuzzed responses 304b, for example, using the client application 112. For example, the client application 112 may be a web browser application, and the fuzzed responses 304b may be web pages requested by the web browser application that are fuzzed by the proxy 104. The client application 112 then processes the fuzzed responses 304b.

The client 102 may include a client status reporting component 306, which may be implemented similarly to the server status reporting component 214 shown in FIG. 2. The client status reporting component 306 may function similarly to the server status reporting component 214, but may be implemented on the client 102 instead. The client status reporting component 306 may be implemented on the computer-readable medium 110. However, the computer-readable medium 110 is omitted from FIG. 3 for clarity. The client status reporting component 306 may be, for example, an application debugger, a memory profiling tool, or the like. As with the server status reporting component 214 discussed above, respective instances of the client status reporting component 306 may be associated with respective threads or processes spawned by the client application 112.

If the client application 112 generates one or more events 308 of interest to the proxy 104 when processing the fuzzed response 304b, the client status reporting component 306 may capture the events 308. Examples of the events 308 may include memory faults, access violations, buffer overflows, allocations or deallocations of memory, or the like. The events 308 may be reported along with related details, such as call stacks, contents of debug registers, exception types, or the like.

One or more of the client status reporting components 306 may report events 308 to a client monitoring component 310. The client monitoring component 310 may be implemented to function similarly to the server monitoring component 216 shown in FIG. 2. For convenience, the events 308 as reported to the client monitoring component 310 by the client status reporting components 306 are denoted at reference 312.

The client monitoring component 310 may be adapted to report the events 312 that are captured on the client 102 to the proxy 104. For example, the client monitoring component 310 may report events 314 to the proxy debugging component 222, which was discussed above with FIG. 2. In turn, the events 314 may be forwarded to the proxy logging component 226, which was also discussed above with FIG. 2. For convenience, the events 314 as forwarded to the proxy logging component 226 are denoted at reference 316.

The proxy logging component 226 may be adapted to log the events 316 and any related details (e.g., call stacks, contents of debug registers, exception types, or the like) in the data store 132. For convenience, the events 316 and related details as stored in the data store 132 are denoted at reference 318. In the data store 132, the events 316 and related details can be correlated with the non-fuzzed responses 304a and the fuzzed responses 304b that triggered the events 316. For convenience, the non-fuzzed responses 304a and the fuzzed responses 304b as stored in the data store 132 are referenced at 320. As discussed above with the events 230 shown in FIG. 2, the data store 132 may be formatted so as to support iteratively replaying the request-response traffic and to correlate failures (as reported in the events 318) with the specific responses and/or requests that led to the failures.

In the foregoing manner, the traffic replay component 302 emulates the server application 126, and enables testing of the client application 112. In some instances, the client application 112 may be tested without the server application 126 running on the server 106.

Having described the above operating environments, the discussion now turns to a description of illustrative process flows for performing various aspects of fuzzing requests and responses using a proxy.

Process Flows

FIG. 4 illustrates a process flow 400 for creating and storing templates, such as the templates 130 shown in FIGS. 1-3. These templates may provide a starting point or basis for fuzzing the requests and responses to test a client and/or a server. The template may provide a record of ordinary expected message traffic resulting from a given series of network transactions between two or more network-aware applications serving in the capacity of server, proxy, or client with at least, but not limited to, one client and one server.

Block 402 installs a legitimate client application, such as a web browser, SOAP client, test application, compatible HTTP client application, or the like. An example client application is shown in FIG. 1 at 112.

Block 404 configuring the client application to use a proxy, such as the proxy 104 shown in FIG. 1. For example, block 404 may include configuring the client application and the proxy to exchange message traffic, such as the message traffic 120a shown in FIG. 1. In but one possible implementation, the message traffic may conform to HTTP.

Block 406 starts a target application running on a server. For example, the FIG. 1 shows a server 106 and server application 126.

Block 408 configures the proxy to log the message traffic. The message traffic may include requests from the client application to the server application, and responses thereto from the server application.

Block 410 exercises the functionality of the server of interest, by causing the client to send appropriate requests through the proxy to the server. An example of message traffic from the proxy to the server is shown at 120b in FIG. 1.

Block 412 receives the responses from the server. Block 414 saves a log of the requests and corresponding responses into a data store for use as a template for the fuzzed requests and/or responses. FIG. 1 shows an example data store 132 and example templates 130 stored therein. In but one possible implementation, blocks 412 and 414 may be performed by the proxy 104. Although not shown in FIG. 4, the responses received from the server in block 412 may be forwarded to the client.

Having described a process for creating the template, the discussion now turns to a description of configuring a client, proxy, and/or server for replaying message traffic and fuzzing.

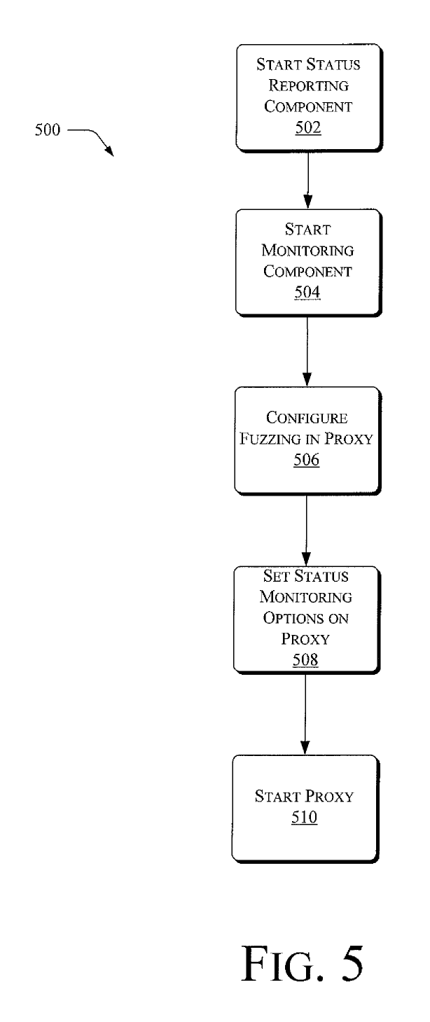

FIG. 5 illustrates a process flow 500 for configuring a client, proxy, and/or server for testing applications on a client or a server by replaying message 8 traffic and fuzzing requests and/or responses. The process flow 500 may be suitable for testing a client or a server, as described in further detail below.

Block 502 starts a status reporting component on the client or server under test. For example, the status reporting component may take the form of an application debugger. Examples of the status reporting component are shown in FIGS. 2 and 3, at 214 and 306, respectively. For example, if an application on the server is to be tested, then block 502 starts a status reporting component on the server (e.g., 214 in FIG. 2). Similarly, if an application on the client is to be tested, then block 502 starts a status reporting component on the client (e.g., 306 in FIG. 3). The status reporting components are associated with executing processes, and report events of interest that occur when these processes execute.

Block 504 starts a monitoring component on the client or server under test. Examples of the monitoring component are shown in FIGS. 2 and 3, at 216 and 310, respectively. For example, if an application on the server is to be tested, then block 504 starts a monitoring component on the server (e.g., 216 in FIG. 2). Similarly, if an application on the client is to be tested, then block 504 starts a monitoring component on the client (e.g., 310 in FIG. 3). It is noted that the monitoring component may be associated with one or more status reporting components, so as to receive reports of events of interest from multiple status reporting components.

Block 506 configures and enables fuzzing in the proxy. Block 508 configures and enables debugging or status monitoring options on the proxy. Examples of such options include which processes to watch, what commands to run to restart them, or the like. Note that in one implementation, processes can be monitored by process id, to select a process individually, or by name, which allows automatically attaching to new processes created with the same name. This feature may be especially suitable for monitoring servers that create new processes under load or restart processes. Block 510 starts the proxy.

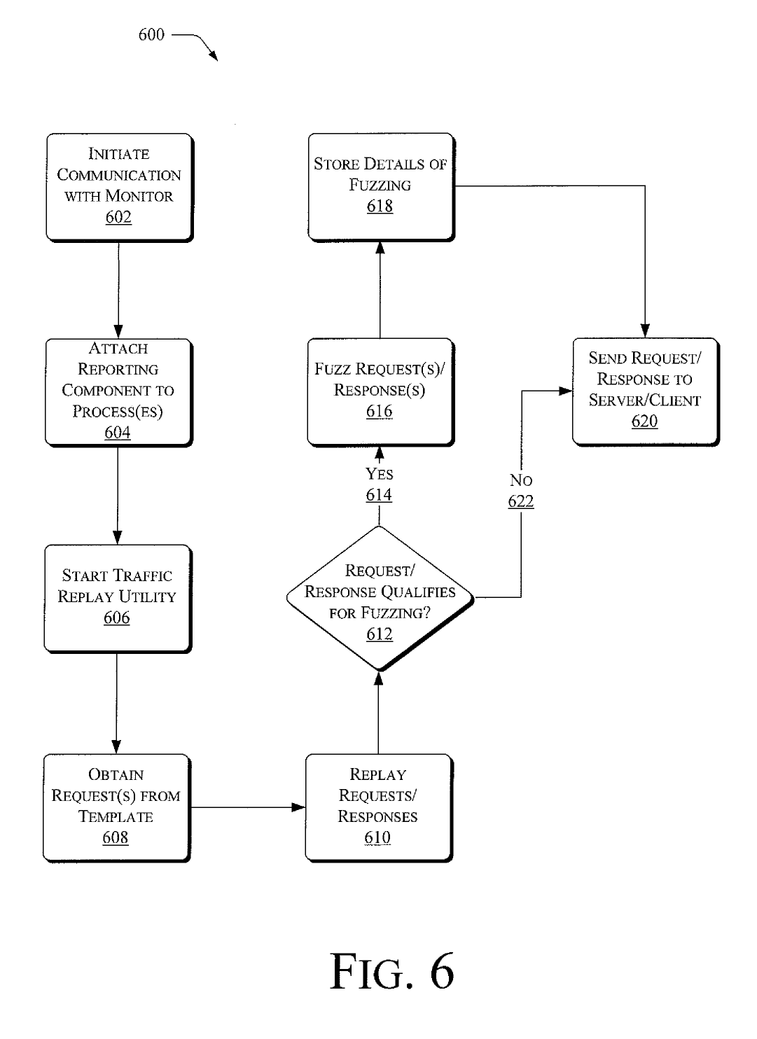

FIG. 6 illustrates a process flow 600 performed after the proxy has been configured and started. FIG. 6 may be performed in connection with testing applications on a server or a client, as described in more detail below.

Once the proxy starts, block 602 initiates communication with the status reporting and monitoring components on the server or client under test. Block 604 initiates the status reporting components (e.g., application debuggers) and attaches them to the processes of interest running on the server or client under test.

Block 606 starts a traffic replay utility on the server or client under test. FIGS. 2 and 3 show examples of the traffic replay utility at 202 and 302, respectively. For example, if an application on the server is to be tested, then block 606 starts a traffic replay utility on the client (e.g., 202 in FIG. 2). Similarly, if an application on the client is to be tested, then block 606 starts a traffic replay utility on the server (e.g., 302 in FIG. 3).

Block 608 looks up information in the proxy log or template, and selects requests or responses to replay. More particularly, if a server application is being tested, block 608 may include selecting requests from the template to be replayed, such that the requests are re-presented to the server after being fuzzed. If a client application is being tested, block 608 may include selecting responses from the template to be replayed, such that the responses are re-presented to the client after being fuzzed.

Block 610 automatically replays the requests and/or responses selected or obtained in block 608. In but one possible implementation, block 610 may be performed by the traffic replay utility (e.g., 202 in FIG. 2). Depending on whether a server application or a client application is being tested, the traffic replay utility may be executing on the client or the server, as described above. If a server application is being tested, block 610 may include replaying a request to the server, for example, by replaying the request using the traffic replay component (e.g., 202 in FIG. 2), and passing the request to the proxy before sending it to the server. If a client application is being tested, block 610 may include replaying a response to the client, for example, by replaying the response using the traffic replay component (e.g., 302 in FIG. 3), and passing the response to the proxy before sending it to the client.

When requests or responses arrive at the proxy, block 612 evaluates them to determine whether they qualify to be fuzzed, based on criteria that may be set by a user of the tools, for example a network-aware software tester (hereafter “tester”). If the request or response qualifies to be fuzzed, then the process flow takes Yes branch 614 to block 616 to fuzz the request or response. Block 616 may include calling a fuzzing add-in API, which may determine which part of the request or response to fuzz, as configured by the tester. The API may also specify what fuzzing strategy to use. For example, the tester can specify whether to extend the information present in the request or response, replace such information, or the like. The API may also tell the proxy what change to make, and the change is made automatically.

Block 618 stores the details of how a particular request or response was fuzzed in a data store that contains combined results data. An example of such a data store is the data store 132. In some implementations, the combined results data is interchangeable or compatible with the proxy log or templates, to facilitate replay scenarios more readily.

Block 620 sends the fuzzed request to the server, or sends the fuzzed response to the client, depending on whether a server application or a client application is being tested.

Returning to block 612, if the request or response does not meet the criteria applicable to fuzzing, then the process flow 600 takes No branch 622 to block 620. In this case, blocks 616 and 618 are bypassed, and the request or response is not fuzzed. Instead, the request or response is sent as-is to the server or client.

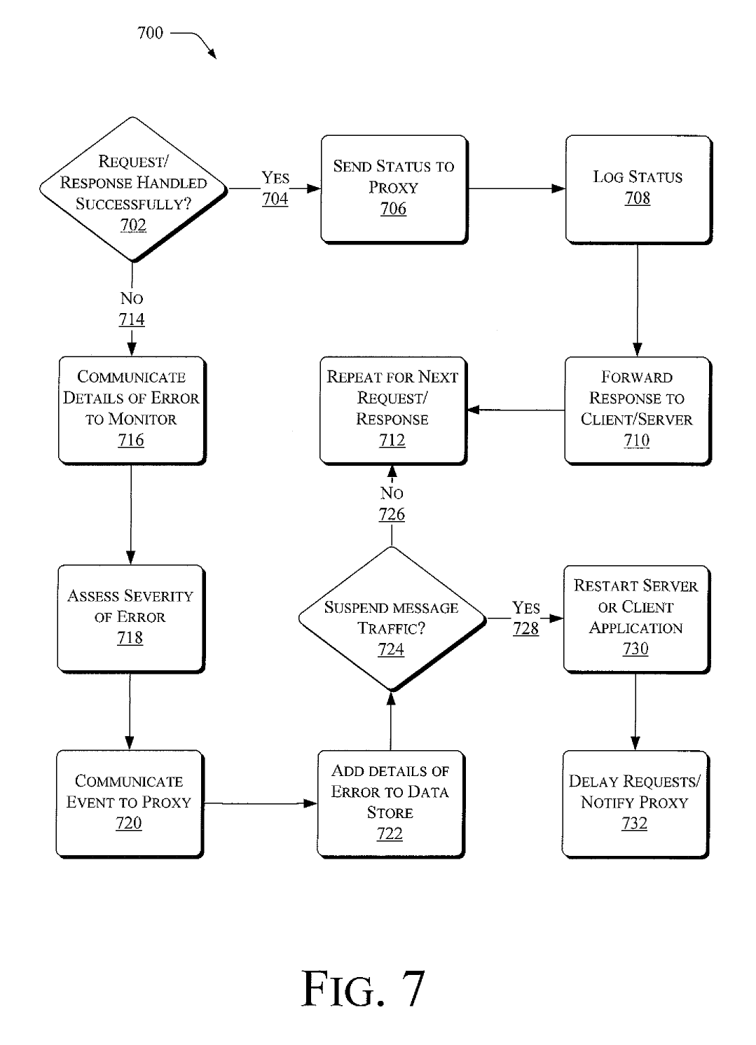

The processing of the fuzzed request or response at the server or client is described in connection with FIG. 7.

FIG. 7 illustrates a process flow 700 performed to process a fuzzed request or response at the server or client under test. FIG. 7 may be performed in connection with testing applications on a server or a client, as described in more detail below.

Block 702 evaluates whether the fuzzed request or response was handled successfully by the server or client under test. If so, the process flow 700 takes Yes branch 704 to block 706, which reports a status back to the proxy.

Block 708 then logs the status, indicating that the fuzzed request or response was handled successfully. Block 708 may be performed by the proxy. For example, the status can be logged into a data store such as the data store 132.

Block 710 forwards the response or request to the client or server, respectively. For example, the proxy may be testing a server application by sending it a fuzzed request. If the server application successfully processes the fuzzed request and provides a valid response back to the proxy, then block 710 includes forwarding the valid response to the client. Similarly, the proxy may be testing a client application by returning it a fuzzed response. If the client application successfully processes the fuzzed response, then block 710 includes notifying the server that the response was processed successfully.

After performing blocks 706-710, the process may be repeated for the request or response extracted from the template. Thus, a process flow may return to block 610 for this next request or response, as represented in block 712.

Returning to block 702, if the request or response is not handled successfully by the client or server application under test, then the process flow 700 takes No branch 714 to block 716. Block 716 communicates the details of the error (e.g., call stack, debug registers, type of exception, or the like) to a monitor component executing on the client or server under test. Examples of the monitor components are the server monitoring component 216 shown in FIG. 2 and the client monitoring component 310 shown in FIG. 3. Block 716 may be performed by, for example, the status reporting component (e.g., 214 and 306 in FIGS. 2 and 3, respectively).

Block 718 assesses the severity of the error, and may be performed by, for example, the monitor component executing on the client or server under test. If the error is sufficiently severe, block 720 communicates the event back to the proxy debug components. In but one possible implementation, the event can be communicated via a separate means from the network message traffic being targeted. The targeted network message traffic is represented by 120 in FIG. 1, for example. The event can be communicated via a special TCP protocol. Examples of the proxy debug components may include the proxy debugging component 222 and the proxy logging component 226, shown in FIGS. 2 and 3.

Block 722 adds the event details to the combined results data stored in the data store 132, associating the event details with the non-fuzzed and fuzzed request or response that triggered the event. Block 722 may be performed by the proxy logging component 226.

Block 724 evaluates the type of event that occurred, and determines whether to suspend test message traffic. For example, the server or client application under test may have crashed when processing the fuzzed request or response, rendering further testing pointless until the server or client application is restarted. If test message traffic is not to be suspended, the process flow 700 takes No branch 726 to block 712, which was described above.

Returning to block 724, if test message traffic is to be suspended, then the process flow 700 takes Yes branch 728 to block 730, where the client or server application under test is restarted. For example, the status reporting component (e.g., 216 and 310 in FIGS. 2 and 3, respectively) may restart the client or server application under test.

In some implementations, when the client or server application under test has been restarted and is ready to accept more test cases, block 732 may notify the proxy accordingly. The proxy, upon receiving a message that the process has restarted, can optionally delay accepting new client requests for a configurable amount of time, allowing time for the process restart to complete. For example, block 732 may be performed using the same means as block 720 uses as described above, such as a customized TCP protocol. At this point, testing may resume, either with the current test case or the next test case. Alternatively, testing may be suspending pending further investigation.

The process flows 500, 600, and 700 may be repeated or continued for as long as the tester configured, until the tester intervenes, or a more severe event prevents operation of the process flows 500, 600, and 700, such as the server or client running out of disk space.

For convenience only, the process flows 500, 600, and 700 are described above in connection with certain components shown in the operating environments 100, 200, and 300. However, it is noted that the process flows 500, 600, and 700 may be performed, in whole or in part, using components other than those described herein without departing from the scope and spirit of the description herein.

Having described the above process flows, the discussion now turns to an illustrative user interface that may present results of the testing described above.

User Interface

FIG. 8 illustrates an example of a user interface 800 that may be presented to the tester. The user interface 800 may enable the tester to review the integrated results of the testing runs described above. In viewing these results, the user interface 800 may enable the tester to select certain requests to be replayed in efforts to reproduce a problem. In response, the user interface 800 may be adapted to automatically trigger the traffic replay utility to send those selected requests sequentially to reproduce the issue. This may allow the tester to narrow down which request caused a problem with the server or client application under test. Additionally, the user interface 800 may provide details from the monitoring of the server or client application, so the tester can include these details when reporting the issue to the responsible programmer(s), so they can address the errors.

Turning to the user interface 800 in more detail, an area 802 may contain representations of various events that occurred during the testing runs described above. The area 802 may be populated by extracting event data from a data store, such as the data store 132. Note that the area 802 can indicate whether particular events are requests or responses, or whether the request or response was changed or unchanged (i.e., fizzed or non-fuzzed).

The area 802 may be responsive to user input to select one or more of the events. Examples of user selection input may include mouse and/or keyboard input. More detailed data related to these selected events may be presented in an area such as the area 804. As shown in FIG. 8, seven events are block-selected in the area 802, and additional data related to the selected events is presented in area 804. The events shown in the area 802 are arranged in sequential order, with the most recent event shown at the bottom of the area 802. Thus, the last event indicates a second-chance null-write access violation. Further details pertaining to the sequence of events leading to this second-chance null-write access violation are shown in the area 804. Further details pertaining to the second-chance null-write access violation itself are shown in an area 806.

The user interface 800 may also include a series of tools that enable the tester to adjust the data presented in the user interface 800. For example, checkboxes 808 enable the tester to select whether or not to display date and time data in the area 802. Custom filtering tool 810 enables the tester to specify strings that may be used to either include or exclude events from being displayed in the area 802. Search/highlight tool 812 enables the tester to locate particular events, and to select a next or previous event.

Checkboxes 814 enable the tester to select event types to display. Individual ones of the checkboxes 814 either enable or disable display of requests, responses, pre-edited (fuzzed) events, post-edited (fuzzed) events, server monitor 9 events, or events corresponding to known issues.

Export tool 816 enables the tester to export selected items, for example, in binary format or XML format. Known issue tool 818 enables the tester to edit descriptions of known events, or to add additional known events. Replay tool 820 enables the tester to replay one or more items that are selected in the area 802 against one or more specified servers or clients.

Area 822 presents an itemized summary of debug events as reported in the area 802. Button 824 enables the tester to refresh the view of events shown in the area 802. Button 826 enables the tester to delete the contents of the data store from which the user interface 800 reads, such as the data store 132.

The above illustration and description of the user interface 800 is presented only for convenience, but not limitation. Thus, it is noted that implementations of the user interface 800 could differ visually from that shown in FIG. 8 without departing from the scope and spirit of the description herein. For example, some implementations of the user interface 800 could be configured and formatted differently than that shown in FIG. 8, could include fields and/or tools that are arranged differently than shown in FIG. 8, and could include fewer or more fields and/or tools than shown in FIG. 8.

### CONCLUSION

Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

Certain data structures are described herein in block form. It is understood that the block elements shown herein are shown and labeled only for convenience. Implementations of these data structures could include sub-sets or super-sets of the elements described and illustrated herein, and could include elements labeled or referenced differently than the elements herein, without departing from the spirit and scope of the description herein

In addition, regarding certain flow diagrams described and illustrated herein, it is noted that the processes and sub-processes depicted therein may be performed in orders other than those illustrated without departing from the spirit and scope of the description herein.

1. A System comprising:
at least one server including a server application;
at least one proxy adapted to communicate message traffic between at least one client and the server, wherein the at least one proxy is adapted to:
store at least one template resulting from the message traffic into a data store;
fuzz at least one request that is selected from the template; and
send the fuzzed request to the server as a test case; and
wherein the server is adapted to process the fuzzed request using the server application, and wherein the server includes at least one server status reporting component that is adapted to receive data representing at least one event that results from processing of a fuzzed request on the server.

2. The system of claim 1, further comprising the client, and wherein the client includes a traffic replay component that is adapted to receive the template, to select the request from the template, and to present the request to the proxy.

3. The system of claim 1, wherein the proxy is adapted to log the request and the fuzzed request into the data store.

4. The system of claim 1, wherein the server and the proxy are implemented on one machine.

5. The system of claim 2, wherein the server, the client, and the proxy are implemented on separate respective machines.

6. The system of claim 1, wherein the server includes a server monitoring component that is coupled to communicate with the server status reporting component, and is adapted to receive at least one report corresponding to the event.

7. The system of claim 1, wherein the proxy includes a proxy debugging component that is coupled to receive at least one report of at least one event that occurs on the server as a result of the server processing at least one fuzzed request.

8. The system of claim 7, wherein the proxy includes a proxy logging component that is adapted to store details relating to the event in the data store, and to associate the event at least with the fuzzed request.

9. A system comprising:
at least one client including a client application;
at least one proxy adapted to communicate message traffic between at least one server and the client, wherein the at least one proxy is adapted to:
store at least one template resulting from the message traffic into a data store;
fuzz at least one response that is selected from the template; and
send the fuzzed response to the client as a test case; and
wherein the client is adapted to process the fuzzed response using the client application, and wherein the client includes at least one client status reporting component that is adapted to receive data representing at least one event that results from processing a fuzzed response on the client.

10. The system of claim 9, further comprising the server, and wherein the server includes a traffic replay component that is adapted to receive the template, to select at least one response from the template, and to present the response to the proxy.

11. The system of claim 9, wherein the proxy is adapted to log the response and the fuzzed response into the data store.

12. The system of claim 10, wherein the server, the client, and the proxy are implemented on separate respective machines.

13. The system of claim 9, wherein the server and the proxy are implemented on one machine.

14. The system of claim 9, wherein the client includes a client monitoring component that is coupled to communicate with the client status monitoring component, and is adapted to receive at least one report corresponding to the event.

15. The system of claim 9, wherein the proxy includes a proxy debugging component that is coupled to receive at least one report of at least one event that occurs on the client as a result of the client processing at least one fuzzed response.

16. The system of claim 15, wherein the proxy includes a proxy logging component that is adapted to store details relating to the event in the data store, and to associate the event at least with the fuzzed response.

17. A user interface presented by a computer-based system, the user interface comprising:
an area adapted to present information relating to events that are correlated with fuzzed requests that are submitted to a server application under test, or correlated with fuzzed responses that are submitted to a client application under test.

18. The user interface of claim 17, wherein the first area is responsive to input from a tester to select at least one of the events, and further comprising at least a second area that is adapted to present additional information related to the selected event.

19. The user interface of claim 17, further comprising a tool enabling the tester to specify whether the first area is to display at least one of requests, responses, pre-edit events, and post-edit events, and further comprising a tool enabling the tester to replay at least one selected event against a server or a client.

20. The user interface of claim 17, wherein the first area is adapted to enable the tester to select a sequence of events, and further comprising at least a third area that is adapted to display additional details relating to the events.
